(19) United States
(12) Patent Application Publication
(10) Pub. No.: US 2004/0043756 A1
(43) Pub. Date: Mar. 4, 2004

(54) Method and system for authentication in IP multimedia core network system (IMS)

(76) Inventors: Tao Haukka, Oulu (FI); Aki Niemi, Helsinki (FI); Gabor Bajko, Koztelek (HU)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/369,497

(22) Filed: Feb. 21, 2003

Related U.S. Application Data
(60) Provisional application No. 60/407,302, filed on Sep. 3, 2002.

(51) Int. Cl. H04M 1/66

(52) U.S. Cl. 455/411

(57) ABSTRACT

A method and communication system are provided for authenticating a first entity (such as a mobile device) in the communications network. This may include transmitting a register message from the first entity to a second entity. An authentication challenge may be transmitted from the second entity to the first entity. The authentication challenge may include security association parameters within a header field. The response of the challenge may be transmitted from the first entity to the second entity. The response of the challenge may include security association parameters within a header field. A security association may be set up based on the security association parameters.

This application claims priority from U.S. Provisional Application Serial No. 60/407,302, filed Sep. 3, 2002, the subject matter of which is incorporated herein by reference.

### BACKGROUND

1. Field of the Invention

The present disclosure relates to communications systems. More particularly, the present disclosure relates to a communication system in which a user is to be registered and/or authenticated.

2. Description of Related Art

An exemplary IP communications network has been described in Release 5 of the specifications of the 3^{rd} Generation Partnership Project (3GPP). Different technical specifications (available at the 3gpp.org website) address various respective aspects of the network.

3GPP Technical Specification 3G TS 24.229: “SIP Multimedia Call Control Protocol based on SIP and SDP” (TS 24.229 v2.0.0 (2002-02)), the subject matter of which is incorporated herein by reference, addresses a call control protocol between a mobile device (i.e., user equipment (UE), subscriber, etc.) and various network elements such as a Serving Call State Control Function (S-CSCF), Proxy Call State Control Function (P-CSCF), and Interrogating Call State Control Function (I-CSCF). Chapter 5.4.1 of TS 24.229 addresses registration and authentication of a UE with a network element. This document may hereafter be referred to as the SIP specification.

However, SIP is vulnerable to certain attacks such as a man-in-the-middle attack. That is, if a user's IP Multimedia Private Identity (IMPI) becomes known to another person, that other person (fake user) may send fake registration requests to the network which includes the user's IMPI.

### SUMMARY OF THE INVENTION

Embodiments of the present invention may provide a method of authenticating a first entity (such as a mobile device) in a communication network. The method may include transmitting a register message from the first entity to a second entity. An authentication challenge may be transmitted from the second entity to the first entity. The authentication challenge may include security association parameters. A security association may be set up based on the security association parameters.

After transmitting the authentication challenge, embodiments of the present invention may also include transmitting a further register message from the first entity to the second entity. The further register message may include security association parameters of the first entity.

The authentication challenge may include security association parameters of the second entity. Additionally, security association parameters of the first entity may be transmitted within the register message. That is, the register message may include a header field (such as any one of the headers “WWW-Authenticate”, “Proxy-Authenticate”, “Authorization” and “Proxy-Authorization” in SIP). The header field may include security association parameters of the first entity. The authentication challenge may also include a header field where the header field includes security association parameters of the second entity. The header field may further include Digest parameters.

Embodiments of the present invention may further provide a method that includes transmitting a first message from a first entity to a second entity and transmitting a second message from the second entity to the first entity. Security association parameters may be transmitted in the first message and/or the second message and verified in the third message. A security association may be created based on the transmitted security associated parameters.

Other embodiments and features of the present invention will become apparent from the following detailed description taken in conjunction with the annexed drawings, which disclose preferred embodiments of the invention.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 is a block diagram of a system for registration/authentication of a mobile device according to an example embodiment of the present invention;

FIG. 2 is a block diagram of a system for registration/authentication of a mobile device according to another example embodiment of the present invention;

FIG. 3 is a message flow diagram between two entities according to one arrangement;

FIG. 4 is a message flow diagram showing registration/authentication using SIP protocol according to an example embodiment of the present invention; and

FIG. 5 is a message flow diagram showing registration/authentication using SIP protocol according to an example embodiment of the present invention.

### DETAILED DESCRIPTION

Arrangements and embodiments of the present invention may be shown in block diagram form in order to avoid obscuring the invention, and also in view of the fact that specifics with respect to implementation of such block diagram arrangements and embodiments of the present invention may be highly dependent upon the platform within which the present invention is to be implemented. That is, the specifics should be well within the purview of one skilled in the art. Where specific details are set forth in order to describe example embodiments of the invention, it should be apparent to one skilled in the art that the invention can be practiced without these specific details.

Embodiments of the present invention may relate to user registration/authentication in a communications network (such as an IP Multimedia Core Network Subsystem (IMS) of a communications network according to Release 5 of the 3GPP). Embodiments of the present invention may relate to registration/authentication of a mobile device (subscriber) by a network element. The mobile device may be any type of mobile device such as, for example, a mobile phone, personal digital assistant (PDA), etc. In this disclosure, the terms user equipment (UE) and mobile device may be used interchangeably. These terms may represent the same network device.

Embodiments of the present invention may be implemented using currently existing network elements and user equipment. For example, a registration method may be provided in software in certain elements and may be easily controlled according to embodiments of the present invention by making modifications to the existing software. Moreover, embodiments of the present invention are not limited to using a call state control function (CSCF) as the network element, or to an IP Multimedia Core Network Subsystem (IMS). Embodiments of the present invention may be implemented using any other network elements (or multiple network elements) as well as any other type of communications networks.

As is well known in the art, HTTP provides a challenge-response authentication mechanism that may be used by a server to challenge a client request and by a client to provide authentication information. HTTP Authentication including both Basic and Digest Access Authentication is described in “HTTP Authentication: Basic and Digest Access Authentication”, RFC 2617 (June 1999) by Franks et al., the subject matter of which is incorporated herein by reference. As will be described below, embodiments of the present invention may extend HTTP Digest challenges and responses. More specifically, an auth-param field may be extended to contain security association (SA) attributes.

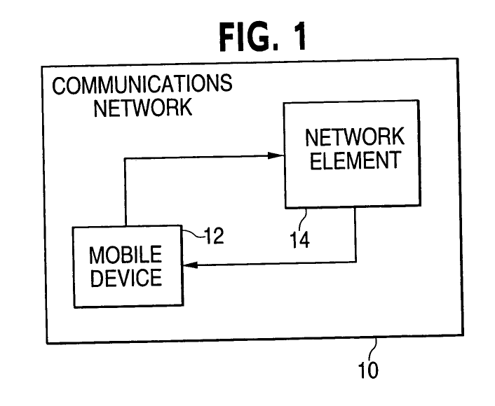

FIG. 1 is a block diagram of a system for registration/authentication of a mobile device according to an example embodiment of the present invention. Other embodiments and configurations are also within the scope of the present invention. As shown, a communications network 10 may include a mobile device 12 and a network element 14. During normal operation, the mobile device 12 sends a request for registration to the network element 14 to register in the communication network 10. Upon receipt, the network element 14 performs an authentication process with the mobile device 12 before registering the mobile device 12. Once the mobile device 12 has been authenticated by the network element 14, the mobile device 12 is then registered in the communication network 10.

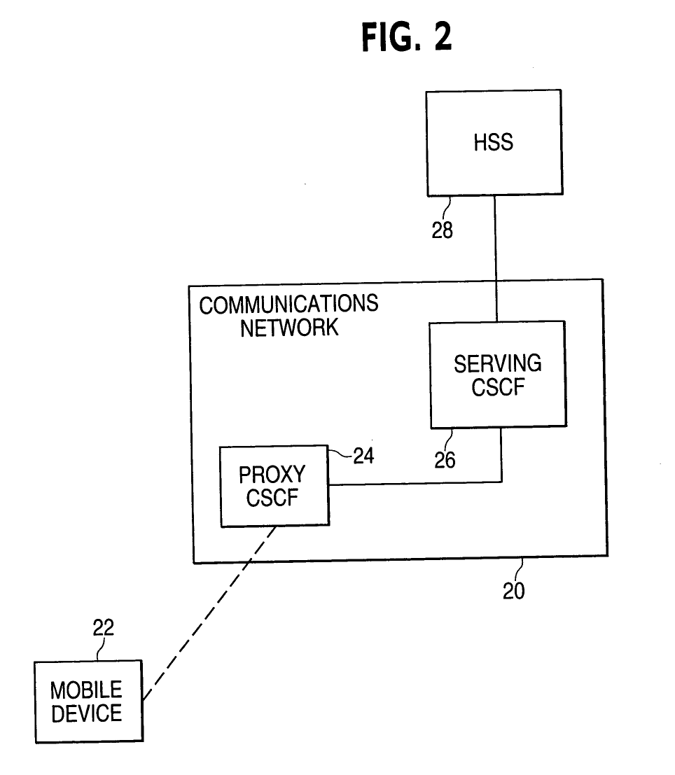

FIG. 2 is a block diagram of a system for registration/authentication of a mobile device according to another example embodiment of the present invention. Other embodiments and configurations are also within the scope of the present invention. In this example embodiment, a communications network 20 may include a mobile device 22, a proxy call state control function (P-CSCF) 24 and a serving call state control function (S-CSCF) 26. The mobile device 22 may interface with the proxy call state control function (P-CSCF) 24, which may in turn interface with the serving call state control function (S-CSCF) 26. The S-CSCF 26 may interface with a Home Subscriber Server (HSS) 28.

The proxy CSCF 24 may contain authentication information regarding the mobile device 22 that may be used to determine whether the mobile device 22 is to be registered. The HSS 22 may also contain registration information regarding the mobile device 22.

In order to lessen the risk of man-in-the-middle attacks, a security association (SA), security agreement or security mechanism may be used. For example, entities involved in the security agreement process may need to determine which security mechanism to apply. The selection of the security mechanism itself may also need to be secure. Additionally, the entities involved in the security agreement process may need to be able to indicate success or failure of the security agreement.

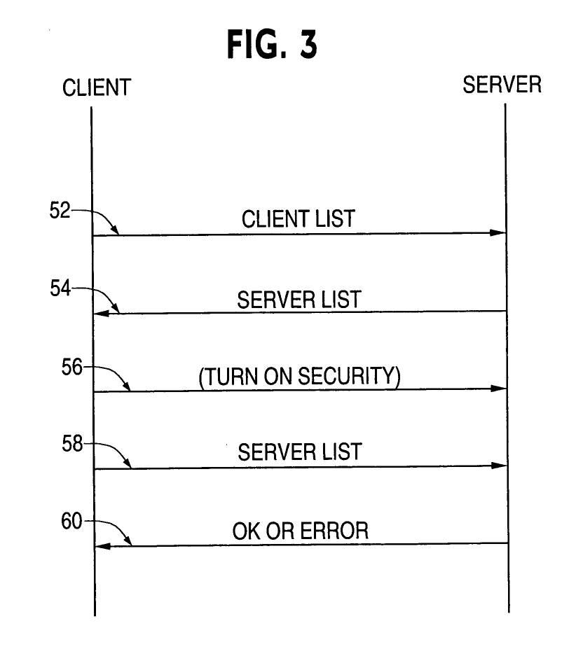

FIG. 3 is a security agreement message flow diagram between a client and a server according to one arrangement. Other arrangements, operations and orders of operations are also possible. More specifically, in operation 52, the client (such as the mobile device 22 in FIG. 2) may send a list (i.e., client list) of supported security mechanisms along with a first request to the server (such as the P-CSCF 24 in FIG. 2). In operation 54, the server may challenge the client to perform the security agreement procedure. The security mechanism and parameters supported by the server (i.e., server list) may be sent back to the client along with this challenge. In operation 56, the client may select a highest-preference security mechanism that the client and server have in common and turn on the selected security. In operation 58, the client may again contact the server using the security mechanism. That is, the server's list of supported security mechanisms may be returned to the server as a response to the authentication challenge. Then, in operation 60, the server may verify its own list of security mechanisms in order to ensure that the original list has not been modified. This is shown as an OK message in FIG. 3. On the other hand, if a proper verification does not occur, then an ERROR message may be returned to the server.

While the above message flow was described as a simple and generic exchange of messages, embodiments of the present invention will now be described with respect to a specific authentication using SIP protocol. More specifically, embodiments of the present invention may extend HTTP Digest challenges and responses. For example, the auth-param field may be extended to contain all IPSec SA attributes for further protection between the entities. The HTTP Digest field may contain the IPSec SA attributes. The following may represent one example set of SA parameters:

auth-param=1*(ipsec-spi/ipsec-port/ipsec-alg/ipsec-mode)

ipsec-spi=1*ipsec-spi-name

ipsec-spi-name=(“ipsec-udp-spi”/“ipsec-tcp-spi”/“ipsec-sctp-spi”) EQUAL ipsec-spi-value

ipsec-spi-value=LDQUOT*LHEX RDQUOT

ipsec-port=1*ipsec-port-name

ipsec-port-name=(“ipsec-udp-port”/“ipsec-tcp-port”/“ipsec-sctp-port” EQUAL ipsec-port-value

ipsec-port-value=1*DIGIT/“*”; Need to check legimity of wildcard here

ipsec-alg=“ipsec-alg” EQUAL (“HMAC-MD5-96”/“HMAC-SHA-1-96”/token)

ipsec-mode=“ipsec-mode” EQUAL (“transport”/“tunnel”)

These example SA parameters may accompany any one of the headers “WWW-Authenticate”, “Proxy-Authenticate”, “Authorization” and “Proxy-Authorization” as set forth in the above-described SIP specification. As is well known to one skilled in the art, these headers may carry the credentials of a user agent (such as a UE). The SA parameters may accompany other headers for other types of registration/authentication.

In the example SA parameters listed above, the parameter ipsec-spi may indicate the entities' service provider interface (SPI) for the security association in hexadecimal format. A different SPI value may be used for each transport protocol. The parameter ipsec-port may define protected ports for each protected protocol. The parameter ipsec-alg may be used to set the used authentication algorithm for the IPSec SA. For example, the authentication algorithm may include HMAC-MD5 and HMAC-SHA-1. The parameter ipsec-mode may be used to select the IPSec mode. For example, either the transport mode or the tunnel mode may be selected.

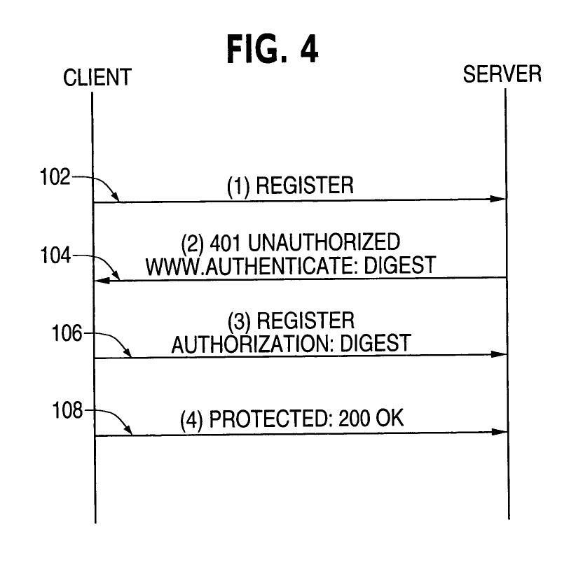

FIG. 4 is a message flow diagram showing registration/authentication using SIP protocol according to an example embodiment of the present invention. Other embodiments, configurations and operations are also within the scope of the present invention. More specifically, FIG. 4 shows the operations (or message flow) involved in registration/authentication of a client (such as the mobile device 22 in FIG. 2) with a server (such as the PCSCF 24 in the communications network 20 in FIG. 2).

In operation 102, the client may send a SIP REGISTER message to register with the communications network 20 (shown as server in FIG.4). In this embodiment, the server may create an authentication challenge and include the server's security association (SA) parameters in the response (RES) message back to the client. That is, in operation 104, the server may respond with a 401 UNAUTHORIZED message (or response). The 401 UNAUTHORIZED message is an authorization challenge that requires the user (i.e., the client) to perform authentication. This 401 UNAUTHORIZED message may include a header field of WWW-Authenticate. The WWW-Authenticate header field includes both the Digest and the server's SA parameters. The SA parameters may be similar to those discussed above or the SA parameters may be different than those discussed above. The WWW-Authenticate header field may be used in a 401 UNAUTHORIZED authentication challenge by a client (such as a user agent). It may contain the nature of the challenge so that the receiver (i.e., the client) may formulate credentials for a subsequent response. The WWW-Authenticate header field allows the client a chance to respond with proper credentials and complete the registration/authentication.

The following is an example of SA parameters contained within the Digest: WWW-Authenticate: Digest

realm=“biloxi.com”,

qop=“auth,auth-int”,

nonce=“dsdfh980f8nj8b7178231237hl98sdnlcls08f”,

opaque=“sdkjuh89f79s8d7hsdf98sd7”,

ipsec-spi=“4784ffe8739aa37ff09bcff”,

ipsec-port=5099,

ipsec-alg=HMAC-MD5-96,

ipsec-mode=transport.

In this example, the parameters “realm”, “qop”, “nonce” and “opaque” represent Digest parameters. The parameters “ipsec-spi”, “ipsec-port”, “ipsec-alg” and “ipsec-mode” represent SA parameters. Other types of parameters and other values for these parameters are also within the scope of the present invention.

The client may then set up an IPSec SA using the SA parameters that were just delivered. In operation 106, the client may send an SIP REGISTER message to the server. The REGISTER message may have an Authorization header field. The Authorization header field may include both the Digest and the client's SA parameters. The SA parameters returned to the server may have different values for each of the parameters (such as the port number, etc.). The returned SA parameters may also include identical values for some of the parameters (such as the mode). The client may query for a password, create Digest credentials and include its SA parameters in the credentials. Subsequently, the server may use the client-provided SA parameters to set up an IPSec security association. Once the IPSec security association has been set up at the server, the server may send a PROTECTED: 200 OK message including a PROTECTED header field in operation 108. The PROTECTED header field may include authentication information (shown as Authentication-lnfo). The message flow of operations 102-108 represents a successful authentication and security association creation.

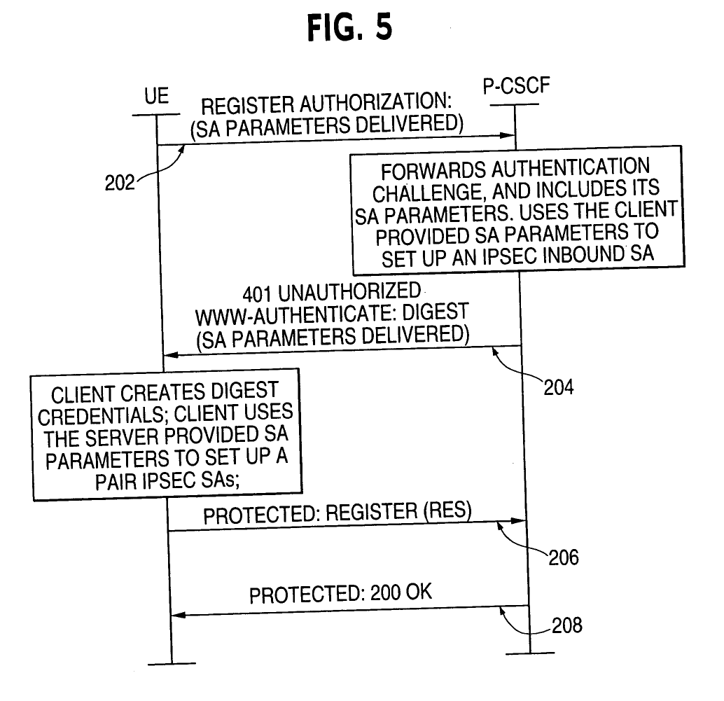

FIG. 5 is a message flow diagram showing registration/authentication using SIP protocol according to an example embodiment of the present invention. Other embodiments, configurations and operations are also within the scope of the present invention. More specifically, FIG. 5 shows the operations (or message flow) involved in registration/authentication of a UE (such as the mobile device 22 in FIG. 2) with a P-CSCF (such as the PCSCF 24 in the communications network 20 in FIG. 2).

In this embodiment, the UE may send SA attributes in a first REGISTER message to the P-CSCF (such as the PCSCF 24 in the communications network in FIG. 2). SA protection based on the SA attributes may then be used for sending the 200OK back to the UE. More specifically, in operation 202, the UE may send a REGISTER message to the P-CSCF. The REGISTER message may include an Authorization header field including SA parameters of the UE. That is, the Authorization header field may be used to carry credentials of the UE in a request to the server. The P-CSCF may forward an authentication challenge to another entity in the communication network and include its SA parameters. The P-CSCF may use the UE's SA parameters to set up an IPSec outbound security association. More specifically, in operation 204, the P-CSCF may send a 401 UNAUTHORIZED response to the UE. The 401 UNAUTHORIZED response is an authorization/registration challenge that requires the UE to perform authentication. This 401 UNAUTHORIZED response may include a WWW-Authenticate header field. The WWW-Authenticate header field includes both the Digest and the SA parameters of the P-CSCF. The WWW-Authenticate header field allows the UE a chance to respond with proper credentials and complete the registration/authentication.

The UE may create Digest credentials and may use the server provided SA parameters to set up the IP Sec security association. In operation 206, the UE may send a PROTECTED: REGISTER message (or response) to the P-CSCF. The P-CSCF may send a PROTECTED: 200 OK message (to the UE). This message flow of operations 202-208 represents a successful authentication and security association creation.

Accordingly, as set forth above, embodiments of the present invention may provide a method of authenticating a first entity (such as a mobile device) in a communication network. The method may include transmitting a register message from the first entity to a second entity. An authentication challenge may be transmitted from the second entity to the first entity. The authentication challenge may include security association parameters. A security association may be set up based on the security association parameters. After transmitting the authentication challenge, embodiments of the present invention may also include transmitting a further register message from the first entity to the second entity. The further register message may include security association parameters of the first entity. The authentication challenge may include security association parameters of the second entity. Alternatively, security association parameters of the first entity may be transmitted within the register message. Each of the register message and the authentication challenge may include a header field (such as any one of the headers “WWW-Authenticate”, “Proxy-Authenticate”, “Authorization” and “Proxy-Authorization” in SIP). The header field may include security association parameters of the respective entities. The header field may further include Digest parameters.

In one example embodiment of the present invention, a set of SA parameters (or attributes) may be added to P-header. For example, when sending a request, the UE may insert local SA attributes to proxy-outbound-SA and when forwarding challenges {RAND, AUTN}, the P-CSCF may add the SA attributes to a header such as Proxy-inbound-SA.

Any reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The foregoing examples have been provided merely for the purpose of explanation and are in no way to be construed as limiting of the present invention. Although embodiments of the present invention have been described herein with reference to particular methods, materials, and embodiments, the present invention is not intended to be limited to the particulars disclosed herein, rather the present invention extends to all functionally equivalent structures, methods and uses.

What is claimed is:

1. A method of authenticating a first entity in a communication network, the method comprising:
transmitting a register message from the first entity to a second entity;
transmitting an authentication challenge from the second entity to said first entity, the authentication challenge including security association parameters; and
setting up a security association based on the security association parameters.

2. The method of claim 1, wherein after transmitting the authentication challenge, the method further comprises transmitting a further register message from the first entity to the second entity, the further register message including security association parameters of the first entity.

3. The method of claim 1, wherein the authentication challenge includes security association parameters of the second entity.

4. The method of claim 1, wherein security association parameters of the first entity are transmitted in the register message.

5. The method of claim 4, wherein the register message includes a header field, the header field to include security association parameters of the first entity.

6. The method of claim 4, wherein the authentication challenge includes security association parameters of the second entity.

7. The method of claim 6, wherein the authentication challenge includes a header field, the header field to include the security association parameters of the second entity.

8. The method of claim 7, wherein the header field further includes Digest parameters.

9. The method of claim 1, wherein the authentication challenge includes a header field, the header field to include the security association parameters.

10. The method of claim 9, wherein the header field further includes Digest parameters.

11. The method of claim 1, wherein communications between the first entity and the second entity use Session Initiated Protocol (SIP).

12. The method of claim 11, wherein the security association parameters accompany one of the headers “WWW-Authenticate”, “Proxy-Authenticate”, “Authorization” and “Proxy-Authorization”.

13. The method of claim 1, wherein the first entity comprises a mobile device.

14. A method comprising:
transmitting a first message from a first entity to a second entity;
transmitting a second message from the second entity to the first entity, wherein security association parameters are transmitted in at least one of the first message and the second message; and
creating a security association based on the transmitted security associated parameters.

15. The method of claim 14, wherein after transmitting the second message, the method further comprises transmitting a third message from the first entity to the second entity, the third message including security association parameters of the first entity.

16. The method of claim 14, wherein the second message includes security association parameters of the second entity.

17. The method of claim 14, wherein security association parameters of the first entity are transmitted in the first message.

18. The method of claim 17, wherein the first message includes a header field, the header field to include security association parameters of the first entity.

19. The method of claim 18, wherein the second message includes security association parameters of the second entity.

20. The method of claim 19, wherein the second message includes a header field, the header field to include the security association parameters of the second entity.

21. The method of claim 20, wherein the header field further includes Digest parameters.

22. The method of claim 14, wherein the second message includes a header field, the header field to include the security association parameters.

23. The method of claim 22, wherein the header field further includes Digest parameters.

24. The method of claim 14, wherein communications between the first entity and the second entity use Session Initiated Protocol (SIP).

25. The method of claim 24, wherein the security association parameters accompany one of the headers “WWW-Authenticate”, “Proxy-Authenticate”, “Authorization” and “Proxy-Authorization”.

26. The method of claim 14, wherein the first entity comprises a mobile device.

27. A communication system comprising:
a user equipment that transmits and receives communications and a control entity that provides control functions in the communication system, and wherein
the user equipment transmits a register message to the control entity;
the control entity transmits an authentication challenge to said user equipment, the authentication challenge including security association parameters; and
the communication network sets up a security association based on the security association parameters.

28. The communication system of claim 27, wherein after transmitting the authentication challenge, the user equipment further transmits a further register message to the control entity, the further register message including security association parameters of the user equipment.

29. The communication system of claim 27, wherein the authentication challenge includes security association parameters of the control entity.

30. The communication system of claim 27, wherein security association parameters of the user equipment are transmitted within the register message.

31. The communication system of claim 30, wherein the register message includes a header field, the header field to include security association parameters of the user equipment.

32. The communication system of claim 30, wherein the authentication challenge includes security association parameters of the control entity.

33. The communication system of claim 27, wherein the authentication challenge includes a header field, the header field to include the security association parameters.

34. The communication system of claim 33, wherein the header field further includes Digest parameters.

35. The communication system of claim 27, wherein communications between the user equipment and the control entity use Session Initiated Protocol (SIP).

36. The communication system of claim 35, wherein the security association parameters accompany one of the headers “WWW-Authenticate”, “Proxy-Authenticate”, “Authorization” and “Proxy-Authorization”.
